(19) United States
(12) Patent Application Publication
(10) Pub. No.: US 2024/0326311 A1
(43) Pub. Date: Oct. 3, 2024

(54) EXTRUSION DIE WITH THERMALLY ISOLATED MOTOR-DRIVEN LIP PROFILE ACTUATORS AND ASSOCIATED METHODS

(71) Applicant: Nordson Corporation, Westlake, OH (US)

(72) Inventors: Salvatore Giovanni IULIANO, Chippewa Falls, WI (US); Michael Kenneth TRUSCOTT, Chippewa Falls, WI (US)

(73) Assignee: Nordson Corporation, Westlake, OH (US)

(21) Appl. No.: 18/576,143

(22) PCT Filed: Aug. 26, 2022
(86) PCT No.: PCT/US2022/075508

§ 371 Date: Jan. 3, 2024

Related U.S. Application Data
(60) Provisional application No. 63/237,580, filed on Aug. 27, 2021.

(51) Int. Cl. B29C 48/31; B29C 48/08; B29C 48/86; B29C 48/92

(52) U.S. Cl. CPC B29C 48/313; B29C 48/08; B29C 48/865; B29C 48/92; B29C 2948/92133; B29C 2948/92409; B29C 2948/92628; B29C 2948/92904

(57) ABSTRACT

Systems and methods are disclosed for adjusting thickness of an extrudate in an extrusion die system. A lip adjustment assembly includes an engagement member connected to a movable lip of an extrusion die and being movable in a first and second direction opposite the first direction; an actuator configured to move the engagement member in the first and second directions; a coupler connected to both the engagement member and the actuator and disposed between the engagement member and the actuator; and an insulator on the coupler and configured to impede conduction of heat from the engagement member to the actuator. When the engagement member is moved in the first direction, the movable lip is moved toward a second lip of the extrusion die, and when the engagement member is moved in the second direction, the movable lip is moved away from the second lip.

### CROSS-REFERENCE TO RELATED APPLICATIONS

This application is a National Stage Application of International Patent App. No. PCT/US2022/075508, filed Aug. 26, 2022, which claims the benefit of U.S. Provisional Patent App. No. 63/237,580, filed Aug. 27, 2021, the entire disclosures of both of which are hereby incorporated by reference as if set forth in their entirety herein.

### TECHNICAL FIELD

This disclosure generally relates to an extrusion die having a lip adjustment assembly, and more particularly to an extrusion die having a lip adjustment assembly for changing the parameters of the extruded material. This disclosure further generally relates to a method of adjusting thicknesses of an extrudate material, and more particularly relates to a method of implementing an extrusion die having a lip adjustment assembly for changing the parameters of the extruded material.

### BACKGROUND

Extrusion dies can be used to form polymer films, laminates, and/or the like. A pumping device, such as an extruder or a gear pump, forces a molten material, such as polymeric material, through the extrusion die with an exit orifice that has a gap defined by spaced apart lips to form an extruded film, typically called an extrudate. The extrudate is cooled as it exits that gap. The size of the gap, among other factors, can define the thickness, gauge, and/or another dimension of the extrudate. A lip adjustment assembly can be used to help control width-wise variations in extrudate gauge. Lip adjustment assemblies typically include a translator and a rod coupled to the translator. In existing systems, the translator can be configured to expand and contract in response to temperature changes. Such expansion and contraction may typically cause the rod to move, which, in turn, causes the lip to move thereby adjusting the gap dimension as needed. Movement of the translator can be controlled with a control system during processing in response to a gauge measurement at or downstream from the gap. The translator can also be manually adjusted as needed to adjust the gap dimension.

Adjustment of the lip can often take a substantial amount of time, and can sometimes result in too much or too little adjustment. The process is often time-consuming and requires continuous monitoring to ensure the desired result is achieved. The adjustment process can also negatively affect the flow of the material through the extrusion die, which can lead to undesirable final product formation.

Therefore, there is a need for an improved lip adjustment assembly that increases the accuracy of the lip adjustment without adversely affecting the extrudate, decreases the amount of time to implement adjustments, and/or the like.

### SUMMARY

The foregoing needs are met by various aspects of extrusion die systems, extrusion dies, and lip adjustment assemblies disclosed. According to an aspect of this disclosure, a lip adjustment assembly for adjusting thickness of an extrudate includes an engagement member operably connected to a movable lip of an extrusion die, the engagement member being movable in a first direction and in a second direction opposite the first direction; an actuator configured to selectively move the engagement member in the first direction and in the second direction; and a coupler operably connected to both the engagement member and the actuator, such that the coupler is disposed between the engagement member and the actuator. When the engagement member is moved in the first direction, the movable lip is moved toward a second lip of the extrusion die, and when the engagement member is moved in the second direction, the movable lip is moved away from the second lip.

Optionally, the actuator may include a stepper motor having a rotational component and a linear component, wherein movement of the rotational component in a first rotational direction causes movement of the linear component in a first linear direction, and movement of the rotational component in a second rotational direction opposite the first rotational direction causes movement of the linear component in a second linear direction opposite the first linear direction.

Optionally, the linear component may be configured to be moved by a predetermined linear distance that is proportional to a predetermined rotational distance of the rotational component.

Optionally, the lip adjustment assembly may include an insulator disposed on the coupler. The insulator can be configured to impede conduction of heat from the engagement member to the actuator. The coupler can have a first thermal conductivity, the insulator can have a second thermal conductivity, and the second thermal conductivity can be lower than the first thermal conductivity.

Optionally, the coupler may include a recess configured to receive the insulator therein.

Optionally, the coupler may include a first portion coupled to the actuator and a second portion coupled to the engagement member, the first portion being spaced from the second portion.

Optionally, the first portion may include a first recess, and the second portion may include a second recess. The insulator can be disposed in the first and second recesses.

Optionally, the insulator can be disposed between the first portion and the second portion.

Optionally, the insulator can include a mica board and/or an engineering-grade polymer, such as polyimides, polyamide-imides, polyetheretherketones, polyphenylene sulfides, polybenzimidazoles, polyetherimides, fluoropolymers.

Optionally, the actuator, the coupler, and the engagement member that are connected to each other can constitute a set of components. The lip adjustment assembly can include a plurality of sets of components, with each set of components having at least one actuator, at least one coupler, and at least one engagement member.

Optionally, the lip adjustment assembly can include a housing configured to at least partly enclose the actuator therein.

Optionally, the housing can include an air vent extending therethrough and configured to permit movement of air into and out of the housing.

Optionally, the lip adjustment assembly can include an air mover configured to actively move air toward or away from the actuator.

Optionally, the lip adjustment assembly can include a controller configured to control operation of the actuator.

Optionally, the lip adjustment assembly can include a plurality of actuators arranged in a linear array, wherein each actuator of the plurality of actuators is spaced from at least an adjacent one other actuator in certain applications by a distance of between about 1 inch and about 4 inches measured between centerlines of each actuator and at least the adjacent one other actuator. In other applications, each actuator may have a different spacing.

According to another aspect, an extrusion die for use with an extrusion die system is disclosed. The extrusion die is configured to receive a material therein and includes a first die body having a first lip; a second die body having a second lip; and a gap defined between the first lip and the second lip, the gap being configured to receive the material therein and to extrude the material therefrom. The extrusion die is configured to be operably connected to a lip adjustment assembly for adjusting a thickness of the extruded material. The lip adjustment assembly can include an engagement member operably connected to one of the first lip and the second lip and being movable in a first direction and in a second direction opposite the first direction; an actuator configured to selectively move the engagement member in the first direction and in the second direction; and a coupler operably connected to both the engagement member and the actuator, such that the coupler is disposed between the engagement member and the actuator. When the lip adjustment assembly is connected to the extrusion die and the engagement member of the lip adjustment assembly is moved in the first direction, the one of the first lip and the second lip is moved toward the other of the first lip and the second lip, and when the engagement member is moved in the second direction, the one of the first lip and the second lip is moved away from the other of the first lip and the second lip.

Optionally, the extrusion die can include an insulator configured to impede heat transfer from the extrusion die to the lip adjustment assembly when the lip adjustment assembly is connected to the extrusion die. The coupler can have a first thermal conductivity, the insulator can have a second thermal conductivity, and the second thermal conductivity can be lower than the first thermal conductivity.

Optionally, the insulator can include a mica board. The insulator can include an engineering-grade polymer, such as polyimides, polyamide-imides, polyetheretherketones, polyphenylene sulfides, polybenzimidazoles, polyetherimides, fluoropolymers.

Optionally, one of the first lip and the second lip can be configured to be deformed non-linearly along a length thereof by a plurality of actuators, couplers, and engagement members of the lip adjustment assembly.

Optionally, the extrusion die can include a heater configured to heat the material in the extrusion die. Optionally, the extrusion die can include a heater configuration to heat the material in the extrusion die.

Optionally, one of the first and second die bodies can include a flexible hinge adjacent the respective first or second lip, the flexible hinge being configured to deform when one of the first and second lips is moved towards or away from the other of the first and second lips.

Optionally, one of the first and second lips can be configured to be moved by the lip adjustment assembly while the other of the first and second lips is not movable by the lip adjustment assembly.

According to another aspect, an extrusion die system for forming extrudate from a material is disclosed. The extrusion die system includes an extrusion die having a first die body having a first lip; a second die body having a second lip; and a gap defined between the first lip and the second lip, the gap being configured to receive the material therein and to extrude the material therefrom. The extrusion die system further includes a heater configured to heat the material in the extrusion die and a lip adjustment assembly. The lip adjustment assembly can have: an engagement member operably connected to one of the first lip and the second lip and being movable in a first direction and in a second direction opposite the first direction; an actuator configured to selectively move the engagement member in the first direction and in the second direction; and a coupler operably connected to both the engagement member and the actuator, such that the coupler is disposed between the engagement member and the actuator. When the engagement member is moved in the first direction, the one of the first lip and the second lip is moved toward the other of the first lip and the second lip, and when the engagement member is moved in the second direction, the one of the first lip and the second lip is moved away from the other of the first lip and the second lip. The extrusion die system further includes a controller configured to control operation of the heater and the lip adjustment assembly. Optionally, the extrusion die can include a heater configuration to heat the material in the extrusion die.

Optionally, the actuator can include a stepper motor having a rotational component and a linear component, wherein movement of the rotational component in a first rotational direction causes movement of the linear component in a first linear direction, and movement of the rotational component in a second rotational direction opposite the first rotational direction causes movement of the linear component in a second linear direction opposite the first linear direction.

Optionally, the linear component can be configured to be moved by a predetermined linear distance that is proportional to a predetermined rotational distance of the rotational component.

Optionally, the lip adjustment assembly may include an insulator disposed on the coupler. The insulator can be configured to impede conduction of heat from the engagement member to the actuator. The coupler can have a first thermal conductivity, the insulator can have a second thermal conductivity, and the second thermal conductivity can be lower than the first thermal conductivity.

Optionally, the coupler can include a recess configured to receive the insulator therein.

Optionally, the coupler can include a first portion coupled to the actuator and a second portion coupled to the engagement member, the first portion being spaced from the second portion.

Optionally, the first portion can include a first recess and the second portion includes a second recess, the insulator being disposed in the first and second recesses.

Optionally, the insulator can be disposed between the first portion and the second portion.

Optionally, the insulator can include a mica board or another material. The insulator can include an engineering-grade polymer, such as polyimides, polyamide-imides, polyetheretherketones, polyphenylene sulfides, polybenzimidazoles, polyetherimides, fluoropolymers.

Optionally, the actuator, the coupler, and the engagement member that are connected to each other can constitute a set of components, and the lip adjustment assembly can include a plurality of sets of components, with each set of components having at least one actuator, at least one coupler, and at least one engagement member.

Optionally, the extrusion die system can include a housing configured to at least partly enclose the actuator therein.

Optionally, the housing can include an air vent extending therethrough, the air vent being configured to permit movement of air into and out of the housing.

Optionally, the extrusion die system can include an air mover configured to actively move air toward or away from the actuator.

Optionally, the extrusion die system can include a plurality of controllers.

Optionally, the actuator can be spaced from the extrusion die by at least 6 inches.

Optionally, the extrusion die system can include a plurality of actuators arranged in a linear array, wherein each actuator of the plurality of actuators is spaced from at least an adjacent one other actuator in certain applications by a distance of between about 1 inch and about 4 inches measured between centerlines of each actuator and at least the adjacent one other actuator. In other applications, each actuator may have a different spacing.

Optionally, the extrusion die system can include a heater configured to heat the material in the extrusion die. Optionally, the extrusion die can include a heater configuration to heat the material in the extrusion die.

Optionally, one of the first and second die bodies can include a flexible hinge adjacent the respective first or second lip, the flexible hinge being configured to deform when one of the first and second lips is moved towards or away from the other of the first and second lips.

Optionally, one of the first and second lips can be configured to be moved by the lip adjustment assembly while the other of the first and second lips is not movable by the lip adjustment assembly.

Optionally, the extrusion die system can include an air source spaced from the extrusion die and the lip adjustment assembly.

Optionally, the extrusion die system can include a material source configured to discharge the material therefrom into the extrusion die.

According to another aspect, a method of adjusting a size of a gap between a first lip and a second lip of an extrusion die with an extrusion die system is disclosed. The method includes: determining a desired gap distance between the first lip and the second lip; actuating an actuator of a lip adjustment assembly to cause translation of an engagement member connected to the actuator in a first direction, the translation of the engagement member causing one of the first lip and the second lip to be moved toward or away from the other of the first lip and the second lip; continuing actuation of the actuator until the engagement member has translated a predetermined distance, the predetermined distance being associated with the desired gap distance; and stopping actuation of the actuator to stop translation of the engagement member, which causes the one of the first lip and the second lip to stop being moved toward or away from the other of the first lip and the second lip.

Optionally, the method can include cooling the actuator by removing heated air in contact with the actuator.

Optionally, the method can include cooling the actuator by introducing a coolant into contact with the actuator.

Optionally, the extrusion die system can include a controller having a processor and a memory, and the method can include storing an operational parameter into the memory, the operation parameter including the determined desired gap and the predetermined distance associated with the desired gap in the memory.

Optionally, the method can include retrieving the operational parameter from the memory and actuating the actuator to correspond to the retrieved operational parameter.

Optionally, the extrusion die system can include a plurality of actuators, and the method can include repeating the determining, actuating, continuing, and stopping steps for each of the plurality of actuators.

In one general aspect, a method includes determining a neutral gap distance between a first lip and a second lip. The method in addition includes adjusting a neutral die lip gap by actuating an actuator of a lip adjustment assembly to cause translation of an engagement member connected to the actuator in a first direction, the translation of the engagement member causing one of the first lip and the second lip to be moved toward or away from the other of the first lip and the second lip. The method moreover includes adjusting a die lip gap to a secondary value by actuating an actuator of a lip adjustment assembly to cause translation of an engagement member connected to the actuator in a first direction, the translation of the engagement member causing one of the first lip and the second lip to be moved toward or away from the other of the first lip and the second lip. The method also includes determining the die lip gap at a secondary value. The method further includes storing die lip gap values. The method in addition includes generating control values for subsequent operation of the lip adjustment assembly based on the die lip gap values.

### BRIEF DESCRIPTION OF THE DRAWINGS

The present application is further understood when read in conjunction with the appended drawings. For the purpose of illustrating the subject matter, exemplary aspects of the subject matter are shown in the drawings; however, the presently disclosed subject matter is not limited to the specific methods, devices, and systems disclosed. In the drawings:

FIG. 1 illustrates a perspective view of a portion of an extrusion die system according to an aspect of this disclosure;

FIG. 2 illustrates a side cross-sectional view of the extrusion die system of FIG. 1;

FIG. 3 illustrates a side cross-sectional view of a portion of the extrusion die system shown in FIG. 1;

FIG. 4A illustrates a perspective view of a coupler according to an aspect of this disclosure;

FIG. 4B illustrates a perspective view of a coupler according to another aspect of this disclosure;

FIG. 4C illustrates an exploded view of the coupler of FIG. 4B;

FIG. 5 illustrates a perspective view of a portion of the extrusion die system of FIG. 1 according to another aspect of this disclosure;

FIG. 6A illustrates a top perspective schematic view of a lip adjustment assembly according to an aspect of this disclosure;

FIG. 6B illustrates a top perspective schematic view of a lip adjustment assembly according to another aspect of the disclosure;

FIG. 6C illustrates a front perspective schematic view of a lip adjustment assembly according to yet another aspect of the disclosure; and

FIG. 7 illustrates a flow chart depicting a method of operating an extrusion die system according to an aspect of this disclosure.

FIG. 8 illustrates an exemplary method of calibrating a die lip gap according to aspects of the disclosure.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

Throughout this specification, words are to be afforded their normal meaning as would be understood by those skilled in the relevant art. However, so as to avoid misunderstanding, the meanings of certain terms will be specifically defined or clarified.

The term “plurality,” as used herein, means more than one. The singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

Typical automated control of lip gap profile for extrusion dies is implemented via thermally actuated translator blocks. These are effective at controlling the thickness profile of the extrudate, but do not provide an indication of the actual lip gap. The thermally actuated translator blocks moreover take time to expand and to stabilize. Thermal cross-talk between the environment, the die body, the translator blocks, and/or the like also adds to the control noise. Time constants (the time to travel 62.7% of total expansion) can be from 3 minutes to 12 minutes depending on the design. On the other hand, aspects of the disclosure utilize stepper motors that can change the profile in milliseconds. By counting turns, the precise lip gap profile can be known. Aspects of the disclosure allow for saved lip profile recipes to be launched with extreme precision and speed allowing for minimal waste when changing over from one product to another.

Additionally, extrusion dies typically operate at temperatures ranging from 300 to 630 degrees F. Heat can transfer from the die body to the lip adjustment system. The air surrounding the extrusion die can become very warm and contain fumes of lower molecular weight polymer or monomer. It is desirable to protect the stepper motors from excessive heat and from contamination, which results from condensing of process off-gases. As described herein, various approaches are provided to protect the stepper motors from excessive heat and from contamination. Moreover, aspects of the disclosure include implementations where the stepper motors may be off-mounted on the die body at a distance that sufficiently reduces heat transfer. Further, aspects of the disclosure may implement an array of stepper motors that may be housed in a forced air cooling box with air inlet fans and air outlet vents to keep the stepper motor temperature safely below the design limit. Further, aspects of the disclosure may include fan air inlets that may have ducts and hoses such that the air supply comes from a cooler area, such as a cooler area of a factory that has significantly less process fumes than the area in the extrusion die location.

Additionally, aspects of the disclosure include implementation of stepper motors and the stepper motors are relatively expensive components. Aspects of the disclosure accordingly are configured in a lip adjusting system that contains a minimum number of these parts and with fit-for-use specifications to control cost. Further, aspects of the disclosure may implement the array of stepper motors spaced on centers close enough to allow a processor to sufficiently contort the lip of the system. Aspects of the disclosure may implement the motors to be spaced not so far apart that there would be deflection between adjustments sufficient to cause a thickness control issue. In one aspect of the disclosure, a moment of inertia of typical flex lip designs may result in an optimal spacing from between 2-inch centerlines up to 3.5-inch centerlines. Various aspects of the disclosure may implement a DC stepper motor that turns a shaft that results in simplicity of function and cost control. This rotational movement may be converted to linear movement via a spool that turns threads to profile the flex lip of the die. In various aspects of the disclosure, a specific motor torque range may be used to contort the flex lip and overcome the hydraulic forces from the pressurized polymer in the die lip gap. For example, in one or more aspects 12 ft-lb torque motors may be used as a minimum for lower pressure applications up to 25 ft-lb torque motors for higher pressure applications. In aspects, the motors may be implemented with a torque of 5 ft-lb-100 ft-lb, 5 ft-lb-10 ft-lb, 10 ft-lb-20 ft-lb, 20 ft-lb-30 ft-lb, 30 ft-lb-40 ft-lb, 40 ft-lb-50 ft-lb, 50 ft-lb-60 ft-lb, 60 ft-lb-70 ft-lb, 70 ft-lb-80 ft-lb, 80 ft-lb-90 ft-lb, 90 ft-lb-100 ft-lb, and/or the like.

In further aspects of the disclosure, the motors may need to be periodically disassembled from the die for maintenance or replacement. Accordingly, the disclosed system is configured in order to simplify the disassembly process to allow for routine maintenance to be convenient and efficient. In aspects of the disclosure, the motors may be off-mounted from the die body in modular sub-assemblies. This may be beneficial so the processor may not need to dissemble many parts to get to one specific motor for maintenance.

In various aspects of the disclosure, an array of stepper motors may be attached to the flexible lip body of an extrusion die that may be used to contort the flexible lip so that the gap created between the flexible lip and fixed lip can be profiled to fine-tune the thickness distribution of the extrudate. Aspects of the disclosure may implement a DC stepper motor that turns a shaft for simplicity of function and cost control. In aspects of the disclosure, the rotational movement of the stepper motor may be converted to linear movement via a spool that turns threads to profile the flex lip of the die. Aspects of the disclosure may implement the stepper motors or servo motors to respond to commands from a thickness measurement and control system. Additionally, the various aspects of the disclosure may implement temperature isolation, spacing, torque, sub-assembly, and/or the like as further described herein.

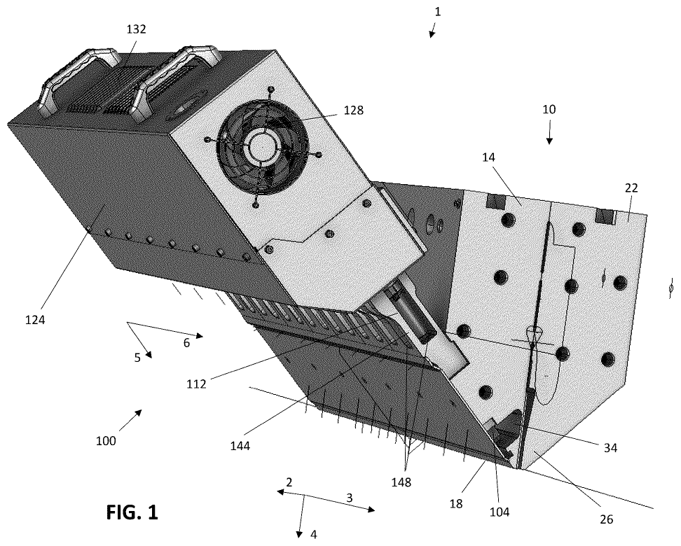

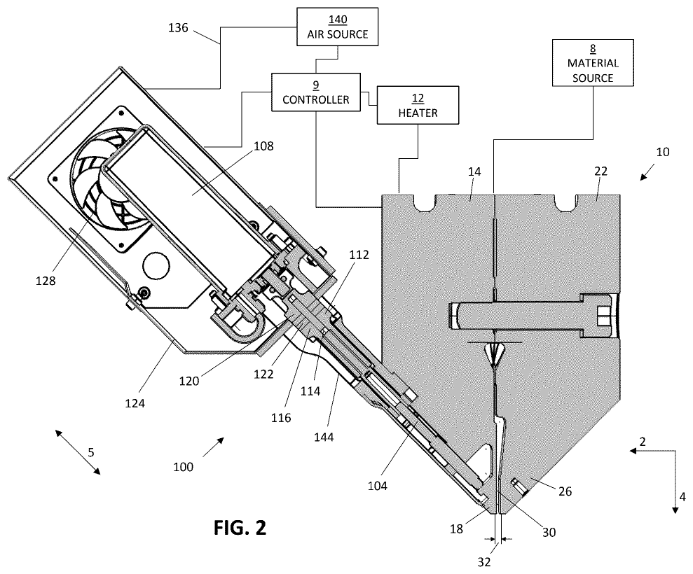

Referring to FIGS. 1 and 2, an extrusion die system 1 for forming a polymeric film or extrudate is illustrated. The extrusion die system 1 is configured to receive a flowable material (e.g., a polymeric material) from a material source 8 (labeled in FIG. 2) and to discharge the flowable material into an extrudate. The extrudate may be discharged onto a substrate (not shown). The extrusion die system 1 includes an extrusion die 10 and a lip adjustment assembly 100 mounted to the extrusion die 10. The lip adjustment assembly 100 can control the gauge of the extrudate being dispensed from the extrusion die 10. The lip adjustment assembly 100 can be configured to change the dimensions and shape of the extrudate. In some aspects, the lip adjustment assembly 100 may change the dimensions and shape of the extrudate at one location of the formed extrudate or at multiple locations as will be described below.

The extrusion die system 1 may include a heater 12 (labeled in FIG. 2) configured to heat the material received into the extrusion die system 1 to form a molten material such as a molten polymer. The molten material can then be moved through and discharged from the extrusion die 10. It will be appreciated that the material can be introduced, heated, and flowed through the extrusion die system 1 according to any known mechanism or method. The material as used herein may be a polymeric material and can include a thermoplastic polymer, synthetic resin, liquid crystalline polymer, and/or the like. It should be understood that other suitable flowable materials can be processed using the extrusion die system 1, for example, an adhesive. The extrusion die system 1 can be configured to process a single polymer or multiple polymers. For example, the extrusion die 10 can define a plurality of different passages each being configured to process and guide different materials to form a multi-component extrudate or film. Furthermore, it should be appreciated that the extrusion die 10 can be used to process non-polymeric materials.

As shown FIGS. 1 and 2, the extrusion die 10 can include a first die body 14 and a second die body 22 that define a gap 30 (illustrated in FIG. 2) between them through which the extrudate can be discharged out of the extrusion die 10. The first die body 14 includes a first lip 18, and the second die body 22 includes a second lip 26 (shown in phantom in FIG. 2). The first lip 18 and the second lip 26 together define an exit opening out of the extrusion die 10 in the form of the gap 30. The first die body 14 and the second die body 22 are positioned opposite with respect to each other along a first direction 2. In this regard, the first lip 18 is positioned opposite and adjacent to the second lip 26. The gap 30 is defined between the first lip 18 and the second lip 26 and extends along the first direction 2 from the first lip 18 to the second lip 26. The gap 30 extends along a second direction 3 that is perpendicular to the first direction 2. During use, the extrudate can exit the gap 30 along a third direction 4 that is perpendicular to the first direction 2 and the second direction 3. In the present disclosure, the first direction 2 can be referred to as a thickness direction, the second direction 3 can be referred to as a width direction, and the third direction 4 can be referred to as a flow direction.

The gap 30 defines a gap thickness or gap distance 32 measured along the first direction 2 between the first die body 14 and the second die body 22, for example, specifically between the first lip 18 and the second lip 26. As illustrated, the gap 30 has a gap distance 32 defined between the first and second die bodies 14 and 22. The gap distance 32 is the size of the gap 30 and corresponds to the distance that separates the first lip 18 and second lip 26 at a given location along the extrusion die 10, for example, along the first direction 2. The lip adjustment assembly 100 is configured to move at least one of the first lip 18 and the second lip 26 to increase or decrease the gap distance 32, which in turn, adjusts the gauge of the extrudate. In some aspects, the lip adjustment assembly 100 may be configured to move the first lip 18 while the second lip 26 is kept stationary. The gap distance 32 may be uniform along the second direction 3 along the entirety of the extrusion die 10. In some aspects, the gap distance 32 may be varied along the second direction 3. The lip adjustment assembly 100 may be configured to change the gap distance 32 by either an identical rate of change or different rates of change along the second direction 3. That is, the gap 30 may be linear or may be a non-linear curve when viewed along the third direction 4 in the plane defined by the first direction 2 and the second direction 3.

As best shown in FIG. 2, at least one of the first lip 18 and the second lip 26 can be moveable to allow for adjustment of the gap distance 32. In accordance with the illustrated embodiment, the first die body 14 can include the movable lip, illustrated as the first lip 18. The first lip 18 can be fixedly attached to the rest of the first die body 14 via a flex hinge 34. The flex hinge 34 may be configured to be deformed by the lip adjustment assembly 100 such that the first lip 18 can be selectively moved towards or away from the second lip 26. When the first lip 18 is moved away from the second lip 26, the gap distance 32 increases, thus increasing the size of the gap 30; when the first lip 18 is moved towards the second lip 26, the gap distance 32 decreases, thus decreasing the size of the gap 30. It will be understood that the flex hinge 34 may be constructed out of a suitable deformable material that is configured to withstand many iterations of deformation substantially without losing its structural integrity. The flex hinge 34 can be thin enough to bend in response to a force applied to the first lip 18 by the lip adjustment assembly 100.

The lip adjustment assembly 100 can be operably connected to the first lip 18. The first lip 18 can be selectively moved towards or away from the second lip 26, thus decreasing or increasing the gap distance 32, respectively. It will be appreciated that, while the illustrated embodiments depict the lip adjustment assembly 100 being configured to contact and move the first lip 18, other embodiments are envisioned where the lip adjustment assembly 100 may be configured to contact and move the second lip 26. In some embodiments, the extrusion die system 1 may include a plurality of lip adjustment assemblies 100 such that each of the first lip 18 and the second lip 26 is operably connected to, and movable by, a separate implementation of the lip adjustment assembly 100. In further embodiments, a single lip implementation of the lip adjustment assembly 100 may be configured to move both the first lip 18 and the second lip 26.

The lip adjustment assembly 100 can include an engagement member 104 that is configured to move the movable lip, for example, the first lip 18. At least a portion of the first lip 18 may be movable relative to the second lip 26 along an actuation direction 5. The actuation direction 5 can include movement in a direction towards the second lip 26 and an opposite direction away from the second lip 26. The engagement member 104 may comprise a rod, a bar, a shaft, a dowel, a pole, a pin, and/or the like that is configured to receive and transmit forces from the lip adjustment assembly 100 to the first lip 18. The engagement member 104 may receive compressive forces to move the first lip 18 along the actuation direction 5 towards the second lip 26 and/or tensile forces to pull the first lip 18 away from the second lip 26 in the opposite direction along the actuation direction 5.

The lip adjustment assembly 100 can further include an actuator 108 configured to move the first lip 18 via the engagement member 104. The actuator 108 can include a motor configured to move the engagement member 104. The actuator 108 may include a linear actuator, such as a stepper motor, a servomotor, and/or the like.

The actuator 108 may be implemented as a device actuator, a motorized actuator, a pneumatic actuator, a hydraulic actuator, and/or the like. The motorized actuator implementations of the actuator 108 may include a DC motor, an AC motor, a self-commutated motor, a brushed DC motor, an electronic commutator (EC) motor, a universal AC/DC motor, an externally commutated AC machine, an induction motor, a synchronous motor, a doubly-fed electric machine, a rotary motor, a linear motor, a stepper motor, a step motor, stepping motor, and/or the like. The pneumatic actuator implementations of the actuator 108 may include a pneumatic motor, an air motor, a compressed air engine, a linear motor, a rotary vane motor, a turbine motor and/or like. The pneumatic actuator implementations of the actuator 108 may include a vane motor, a gear motor, a gerotor motor, an axial plunger motor, a radial piston motor, and/or the like. In aspects, the actuator 108 may be implemented as a motorized actuator in order to beneficially achieve, control, improve and/or the like a speed, a precision, an accuracy, a stability, a repeatability, and/or the like of the actuator 108, the lip adjustment assembly 100, and/or the like. Moreover, in aspects of the disclosure, the actuator 108 implemented as a motorized actuator may be configured to overcome the challenges of utilizing a motorized actuator in a lip adjustment assembly by implementation of a number of features including thermal isolation utilizing an insulation component as described herein.

In one aspect, the actuator 108 may be implemented as a stepper motor, a step motor, stepping motor, and/or the like that divides a full rotation into a number of steps. The actuator 108 implementing a stepper motor may control and/or command the stepping motor to move and hold at one of the plurality of steps without any position sensor for feedback (an open-loop controller).

In one aspect, the lip adjustment assembly 100 may control and/or command the actuator 108 to move and hold with feedback (a closed-loop feedback controller). In this regard, the closed-loop feedback control implementation may be responsive to a sensor, a controller, and/or the like. In aspects, the sensor, the controller, and/or the like may sense and/or determine a current product thickness uniformity, a current coating thickness uniformity, a current film thickness uniformity, a current sheet thickness uniformity, and/or the like. Thereafter, in aspects, the sensor, the controller, and/or the like may send a command to the actuator 108 to improve a current product thickness uniformity, a current coating thickness uniformity, a current film thickness uniformity, a current sheet thickness uniformity, and/or the like. Thereafter, the sensor, the controller, and/or the like may sense and/or determine a changed thickness uniformity, a changed coating thickness uniformity, a changed film thickness uniformity, a changed sheet thickness uniformity, and/or the like and repeat the process of commending the actuator 108 as needed. In one aspects, the lip adjustment assembly 100 may control and/or command the actuator 108 to move and hold with feedback (a closed-loop feedback controller) with saved lip profile recipes to be launched with extreme precision and speed allowing for minimal waste when changing over from one product to another.

The actuator 108 implementing a stepper motor may convert a train of input pulses, which may be square waves, into a precisely defined increment and resulting rotational position. Each pulse provided to the stepper motor may rotate a stepper motor shaft through a fixed angle. The stepper motor may be a permanent magnet stepper motor, a variable reluctance stepper motor, a hybrid synchronous stepper, a unipolar stepper motor, a bipolar stepper motor, and/or the like. The actuator 108 and/or the stepper motor may include one or more driver circuits. The actuator 108 can receive power from a power source (not shown) connected to the lip adjustment assembly 100. The lip adjustment assembly 100 can include a plurality of engagement members 104 and/or a plurality of actuators 108. Each engagement member 104 may be operably connected to a separate implementation of the actuator 108.

In aspects, one or more of the engagement member 104 may be operably connected to a separate implementation of the actuator 108 with a push configuration to push the actuator 108. In aspects, one or more of the engagement member 104 may be operably connected to a separate implementation of the actuator 108 with a pull configuration to pull the actuator 108. In aspects, one or more of the engagement member 104 may be operably connected to a separate implementation of the actuator 108 with a push and pull configuration to push and pull the actuator 108. Alternatively or additionally, two or more engagement members 104 may be movable by a single implementation of the actuator 108. Each actuator 108 may have a torque capacity of between about 10 N-m and about 50 N-m or between about 12 N-m and about 40 N-m.

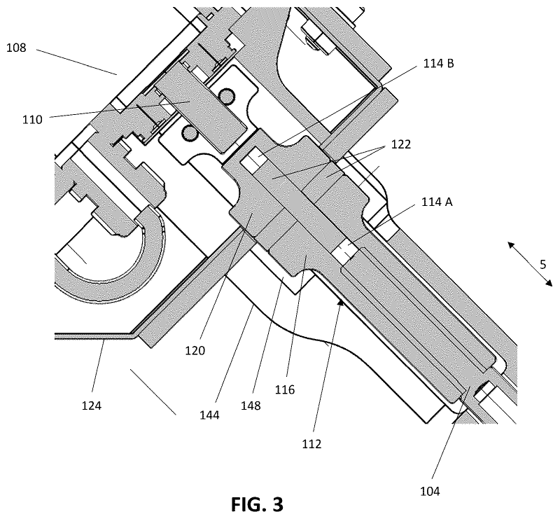

The actuator 108 may include a rotational component (not shown) therein that is configured to translate a linear component 110 (labeled in FIG. 3). The rotational component may include one or more types of mechanisms including a spool that turns threads, a screw, leadscrew, screw jack, ball screw, roller screw, and/or the like. The linear component can be translated along the actuation direction 5 towards or away from the second lip 26. The linear component 110 can be coupled to the engagement member 104, such that when the linear component 110 is moved towards the second lip 26, the engagement member 104 is also moved in the same direction, and when the linear component 110 is moved away from the second lip 26, the engagement member 104 is also moved away from the second lip 26 in the same direction as the linear component 110.

Utilizing the disclosed actuator 108, such as a stepper motor, in the lip adjustment assembly 100 can improve the accuracy and precision of adjustment of the first lip 18 and the gap 30. A stepper motor operates by rotating the rotational component that causes proportional translation of the linear component 110 by a desired distance. The linear component 110 can translate by a fixed linear distance that corresponds to a fixed rotational distance of the rotational component. That is, rotationally moving the rotational component by a first increment results in translation of the linear component 110 by a second increment. This arrangement allows for precise and accurate adjustment of the engagement member 104 connected to the actuator 108. In use, a user may want to move the engagement member 104 by a desired distance toward or away from the second lip 26 in order to decrease or increase the gap distance 32, respectively. Because the engagement member 104 is movable by the translation of the linear component 110, and because the linear component 110 is translatable based on the known ratio of rotational movement of the rotational component, the user can cause the actuator 108 to rotate the rotational component the desired rotational distance in a first or second direction to result in the known desired translational movement of the linear component 110 and the connected engagement component toward or away from the second lip 26.

In existing technology, thermal bolts that are connected to engagement members are heated or cooled to cause expansion or contraction, respectively. As the thermal bolts expand, they cause movement of the engagement members to decrease the gap, and as they thermal bolts contract, they cause movement of the engagement members in the opposite direction to increase the gap. However, since the thermal bolts need time to absorb or radiate heat to expand or contract, respectively, the adjustment of the gap in such designs often takes at least several minutes to achieve. Additionally, it is difficult to properly time when to stop the heating or cooling of the thermal bolts, and the thermal bolts often receive or give off too much heat, which results in overshooting the target expansion or contraction, and which, in turn, results in larger or smaller gap distances, respectively. Furthermore, the existing process is subject to undesired effects of external variables, such as ambient temperature. For example, if the ambient temperature is greater than desired, the thermal bolts will have a higher starting temperature before heat is applied; conversely, if the ambient temperature is lower than desired, the thermal bolts will have a lower starting temperature and will require more heat and heating time to reach the desired temperature. Moreover, existing use of thermal bolt adjustment requires heating of the thermal bolts, and the heat used to heat the thermal bolts can then be conducted or radiated from each thermal bolt toward the extrusion die. This heat can then add undesired heat to the extrusion die and to the material flowing therethrough, thus changing the viscosity, consistency, and/or other flow parameters of the extruded material. This undesired excess heat can result in less accuracy in dispensing the material and can result in unintended thicknesses and/or compositions of the formed extrudate sheets.

The undesired results of the existing thermal bolt adjustment technology described above can be avoided by utilizing the disclosed actuator 108. The actuator 108 allows for instantaneous adjustment without the delay that accompanies the existing thermal bolt technology described above. Additionally, the disclosed actuator 108 provides for accurate adjustment of the gap 30 without risk of overshooting due to the overexpansion or overcontraction of the existing thermal bolts described above. The actuator 108 further allows for accurate adjustment of the gap 30 by the user. The user can determine the exact linear translation of the engagement member 104 along the actuation direction 5 for any given increment of rotational movement of the rotational member of the actuator 108. The determined proportion can allow the user to make accurate adjustments to each engagement member 104 by causing the actuator 108 to move the rotational component by the desired increments. The determined proportions can be utilized at a later time as well, and so the user can make precise and repeatable adjustments to the gap 30 over different operational cycles of the extrusion die system 1. Moreover, because the actuator 108 does not require an application of heat, no excess heat is introduced to the extrusion die 10 that could otherwise adversely affect the characteristics of the melt flow, as in the existing solutions that utilize thermal bolts.

During operation, the extrusion die 10 is configured to be heated to a desired temperature so that the material being extruded can be maintained at the desired temperature, viscosity, consistency, and/or the like. Components of the extrusion die system 1 that are in contact with, or otherwise adjacent to or in proximity to, the heated extrusion die 10 may absorb the heat from the extrusion die 10. The heat can be transferred via direct contact of components with the extrusion die 10 via conduction, convection, and/or the like by being in close proximity to the heated extrusion die 10. In some aspects, it may be beneficial to minimize the amount of heat that is transmitted to components of the extrusion die system 1 outside of the extrusion die 10. For example, it may be beneficial to minimize or decrease the amount of heat transmitted from the extrusion die 10 to the lip adjustment assembly 100. Excessive heat can damage components in the lip adjustment assembly 100, such as the actuator 108. This disclosure considers options of decreasing heat transfer from the extrusion die 10 to the actuator 108 via at least concepts of distancing or spacing the actuator 108 from the heated extrusion die 10 to decrease heat transfer via convection and insulating components to decrease heat transfer via conduction. In some aspects, additional considerations are provided for actively or passively cooling components of the lip adjustment assembly 100, as will be discussed further below.

One mechanism by which the actuator 108 can be protected from heat is by spacing the actuator 108 a suitable distance away from the heated extrusion die 10. In some aspects, the actuator 108 may be disposed at least 4 inches, 5 inches, 6 inches, . . . , or 24 inches away from the extrusion die 10, or another suitable distance at which the actuator 108 is sufficiently spaced from the extrusion die 10 to not receive heat beyond a predetermined threshold amount.

In some aspects, the actuator 108 and the engagement member 104 may be directly connected to each other. In alternative embodiments, the actuator 108 may be connected to the engagement member 104 via a coupler 112. The coupler 112 can be connected to the actuator 108 on one side thereof and to the engagement member 104 on an opposite side thereof. The coupler 112 can include any suitable material configured to withstand the forces being transmitted therethrough between the actuator 108 and the engagement member 104. It should be appreciated that the coupler 112 should be configured to withstand the desired temperature ranges of the extrusion die system 1. In some aspects, the coupler 112 can include steel, such as stainless steel.

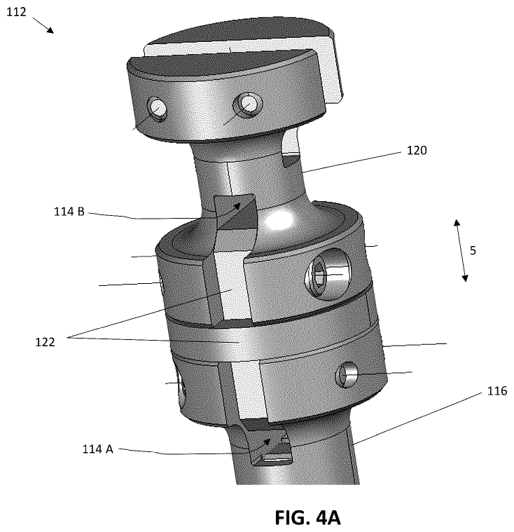

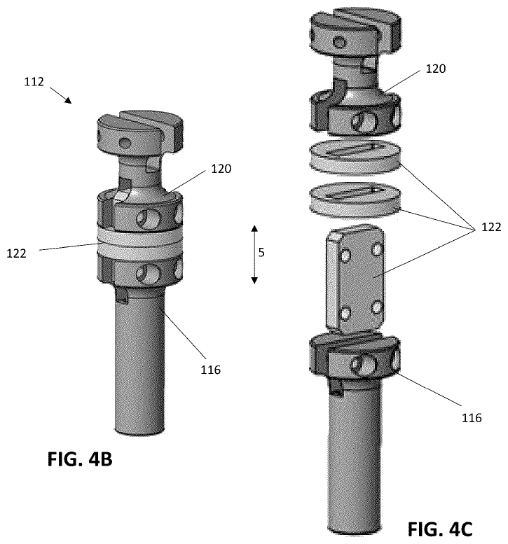

Referring to FIGS. 3, 4A, 4B, and 4C, the coupler 112 may include an insulator or an insulation component 122 thereon or therein. The insulation component 122 may be configured to limit, block, decrease, and/or the like the transfer of heat from the extrusion die 10 along the engagement member 104 to the actuator 108. In aspects, the insulation component 122 may be configured to thermally isolate the extrusion die 10 from the actuator 108. The insulation component 122 may include one or more insulators or insulating components, devices, features, thermal isolation components, and/or the like. The insulation component 122 may include a mica board, a mica sheet having muscovite or phlogopite mica paper bonded with a high quality heat-resisting silicone resin, and/or other material to limit heat transfer. In some aspects, the insulation component 122 may include engineering-grade polymers, such as polyimides, polyamide-imides, polyetheretherketones, polyphenylene sulfides, polybenzimidazoles, polyetherimides, fluoropolymers, and/or the like. The insulation component 122 can include a material that has a lower thermal conductivity than the material comprising the coupler 112. That is, the coupler 112 may have a first thermal conductivity, and the insulation component 122 can have a second thermal conductivity that is lower than the first thermal conductivity. Some exemplary insulation materials can include one or more products manufactured and/or sold by Brandenburger Firmengruppe under the trade names KV® 3, KV® 3eco, BRA-GLA® 3, BRA-GLAR N, and S 4000®. It should be appreciated that the listed products are merely exemplary. The particular material used for the insulation component 122 can be selected based on the anticipated use of the components described herein and the expected temperature ranges, and this description is not intended to be limited by the scope of any particular insulating material. The insulation component 122 may be an insulation assembly comprising a plurality of the insulation component 122 or similar components (see, e.g., the exploded view in FIG. 4C). One or more of the plurality of components may be implemented individual implementations of the insulation component 122 and may be separable from one another.

In some aspects, the coupler 112 may include a first portion 116, fixedly attached to the engagement member 104, and a second portion 120, fixedly attached to the actuator 108, for example, to the linear component 110. The first portion 116 may be separate and spaced from the second portion 120. The insulation component 122 may be at least partly disposed between the first portion 116 and the second portion 120. In some aspects, the coupler 112 may include a groove, a notch, a recess, and/or the like generally referred to hereinafter as a recess 114. The recess 114 may extend along the actuation direction 5 through a portion of the coupler 112. The recess 114 may be configured to receive the insulation component 122 therein. The coupler 112 may have a plurality of recesses 114. As shown in FIGS. 3 and 4A, in some aspects, the first portion 116 of the coupler 112 may have a first recess 114A, and the second portion 120 of the coupler 112 may have a second recess 114B. The insulation component 122 can be disposed in both the first recess 114A and the second recess 114B and extend between the first portion 116 and the second portion 120. The first recess 114A and the second recess 114B may be disposed at the approximate geometric center of the first portion 116 and the second portion 120 of the coupler 112 (when viewed along the actuation direction 5). Such placement of the recesses 114 can help dissipate heat present in the coupler 112 by providing additional surface area for heat to radiate from. Disposing insulation component 122 in the first recess 114A and the second recess 114B can help decrease the amount of heat traveling through the coupler 112. The insulation component 122 being placed at or near the geometric center of the coupler 112 can prevent heat from traveling to the centerline of the coupler 112 and then spreading radially outward towards the outer edges of the coupler 112. Placing the insulation component 122 between the first portion 116 and the second portion 120 of the coupler 112 can also obstruct the heat from traveling up the coupler 112 along the actuation direction 5 towards the actuator 108. It should be appreciated that the insulation component 122 should be configured to withstand compressive, tensile, rotational, and shear stresses applied thereto by the coupler 112 during installation, removal, or use of any of the components described herein.

The extrusion die system 1 may include rigid structural members for supporting and/or connecting various components of the extrusion die system 1, such as one or more components of the extrusion die 10 and one or more components of the lip adjustment assembly 100. Referring again to FIGS. 1 and 2, a frame 144 may extend between the extrusion die 10 and the lip adjustment assembly 100. The frame 144 may be fixedly attached at one end thereof to the extrusion die 10 and/or to the lip adjustment assembly 100 at another end thereof. The frame 144 may be configured to be separated from the extrusion die 10, from the lip adjustment assembly 100, or from both the extrusion die 10 and the lip adjustment assembly 100. In some aspects, the frame 144 may be configured to selectively engage with different embodiments of the extrusion die 10 and/or with different embodiments of the lip adjustment assembly 100. It should be appreciated that the frame 144 should be designed and manufactured so as to withstand the physical forces and pressures associated with supporting the lip adjustment assembly 100 relative to the extrusion die 10 (or vice versa), as well as any other components affixed to or disposed within the frame 144.

In some aspects, the frame 144 may define an interior volume that may house, at least in part, one or more of the components of the lip adjustment assembly 100, such as, but not limited to, the engagement members 104, the couplers 112, and/or the actuators 108. As shown in the illustrative embodiments of FIGS. 1 and 2, the engagement members 104 and at least a portion of each coupler 112 may be disposed within the frame 144 between the extrusion die 10 and the actuator 108. In some aspects, the frame 144 may define one or more openings 148 thereon. Each opening 148 may extend through at least a portion of the frame 144, such that the opening 148 is in communication with the interior volume of the frame 144 and with the environment outside of the frame 144. The opening 148 may be round, rectangular, triangular, oblong, and/or another geometric shape. The frame 144 may include a plurality of openings 148. During operation of the extrusion die system 1, heat may be generated by the movement of the engagement members 104 and/or the couplers 112. Additionally, heat can be transferred from the extrusion die 10 to the engagement members 104 and/or the couplers 112 as described throughout this application. As the components within the frame 144 are heated, the heat can transfer along said components and through the frame 144 toward the actuators 108. The presence of the one or more openings 148 in the frame 144 may allow at least some of the heat to exit the frame 144 and dissipate away from the lip adjustment assembly 100. This can decrease the amount of heat that is transferred to the actuators 108. In some aspects, one or more coolants can be introduced to the engagement members 104 and/or the couplers 112 within the frame 144 through the one or more openings 148. For example, one or more fans 128 may be configured to direct a cooling fluid, such as air, through the one or more openings 148 into the frame 144 to contact the engagement members 104 and/or the couplers 112 therein. Alternatively, or additionally, one or more fans 128 may be configured to extract heated air through the one or more openings 148 from the frame 144.

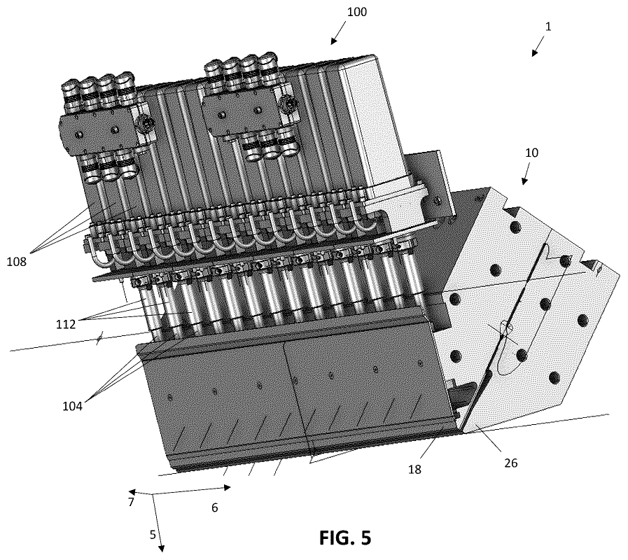

The lip adjustment assembly 100 may include one or more of each of the actuators 108, engagement members 104, couplers 112, and/or the like. In some aspects, the lip adjustment assembly 100 may include a plurality of sets of interconnected components, with each set including one actuator 108, one engagement member 104, and one coupler 112 operatively coupled together. Each set of interconnected components described above can be arranged adjacent to at least one other set of components. As shown in FIG. 5, for example, a plurality of sets of engagement members 104, couplers 112, and actuators 108 can be arranged adjacent one another in a substantially linear array along an array direction 6. The array direction 6 can be substantially orthogonal to the actuator direction 5. In some aspects, the array direction 6 can be parallel to the second direction 3 of the extrusion die system 1. FIG. 5 includes labels for several of each of the actuators 108, couplers 112, and engagement members 104, but it should be understood that the depicted reference numerals apply equally to all like components shown in the figure. As shown in the figures, the lip adjustment assembly 100 may include fourteen sets of connected components, with each set including an actuator 108, a coupler 112, and an engagement member 104. It will be appreciated that other embodiments are envisioned, and that the lip adjustment assembly 100 may include 1, 2, . . . 30, or another suitable number of sets of components as described above.

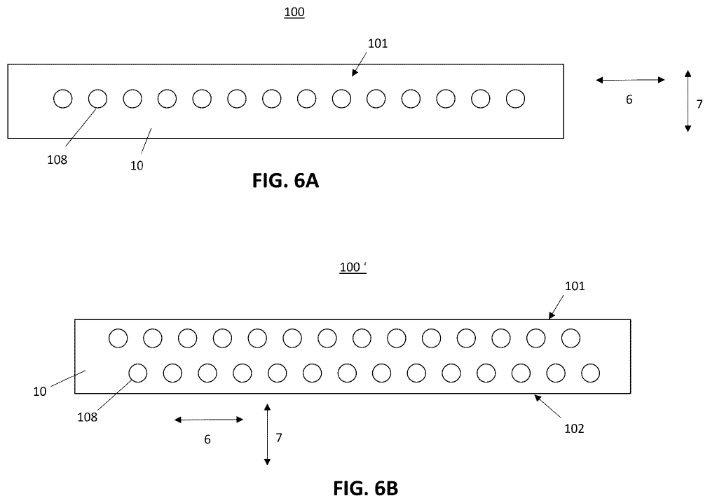

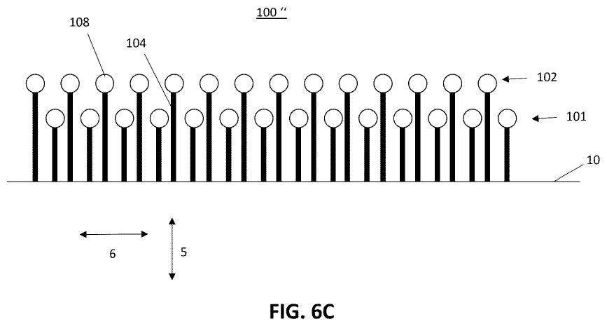

In some aspects, the lip adjustment assembly 100 may include a plurality of array arrangements of sets of connected components. Each set of components in each array can be positioned relative to another set of components or to another component of the extrusion die system 1. The components are described with reference to the actuation direction 5, the array direction 6, and an offset direction 7. The offset direction 7 can be orthogonal to the array direction 6 and to the actuation direction 5. Referring to exemplary FIGS. 6A-6C, schematic views of various embodiments of the lip adjustment assembly 100 are depicted. FIG. 6A shows an exemplary implementation of the lip adjustment assembly 100 having fourteen sets of an actuator 108, a coupler 112, and an engagement member 104. The embodiment depicted in FIG. 6A is shown in a plane defined by the array direction 6 and the offset direction 7. FIG. 6A shows all of the sets (identified by the actuators 108) arranged in a first array 101 along the array direction 6.

FIG. 6B depicts an alternative embodiment showing a lip adjustment assembly 100′, which includes two linear array arrangements of the sets of components described above. The two array arrangements are depicted as a first array 101 and a second array 102. The second array 102 can be spaced from the first array 101 along the offset direction 7.

FIG. 6C depicts yet another embodiment showing a lip adjustment assembly 100″, the schematic being shown in a plane defined by the actuation direction 5 and the array direction 6. The lip adjustment assembly 100″ may include two linear array arrangements of the sets of components described above, with a first array 101 being spaced from a second array 102 along the actuation direction 5. It should be understood that, as shown in the figure, when one or more actuators 108 are spaced further away from the extrusion die 10 than one or more other implementations of the actuators 108, the further spaced actuators may include longer engagement members 104 and/or longer couplers 112. In some aspects, it may be preferable to ensure that the actuators 108 are spaced away from the extrusion die 10 by at least a minimal threshold distance to decrease the amount of heat that can transfer from the heated extrusion die 10 to the actuators 108. The actuators 108 can be spaced from the extrusion die 10 by at least 2 inches, 3 inches, 4 inches, . . . , 24 inches, or another suitable distance. In some particular embodiments, the actuators 108 may be spaced from the extrusion die 10 by about 6 inches.

While FIGS. 6A-6C depict three embodiments showing different numbers and arrangements of arrays of components, it will be appreciated that the lip adjustment assembly 100 may include more arrays in other embodiments, including 3, 4, 5, or another suitable number of arrays of components. It should also be appreciated that embodiments can include combinations of the shown embodiments the lip adjustment assembly 100, the lip adjustment assembly 100′, and the lip adjustment assembly 100″, for example, a lip adjustment assembly 100 may include a first array 101 that is spaced from a second array 102 along both, the actuation direction 5 and the offset direction 7.

Embodiments having a plurality of actuators 108 allow for fine adjustment of the first lip 18 relative to the second lip 26. Each actuator 108 can cause movement of a connected engagement member 104 to cause a portion of the first lip 18 to be moved toward or away from the second lip 26, while one or more adjacent portions of the first lip 18 are not moved or are moved to a different degree. This allows for the first lip 18 to be adjusted along its entire length along the second direction 3 as needed to form the desired gap 30.

The actuators 108 from adjacent sets of components can be spaced from each other at predetermined distances. For example, each implementation of, or one or more implementations of, the actuator 108 can be spaced from any other implementation of the actuator 108 in the lip adjustment assembly 100 by a distance of between approximately 1 inch and approximately 4 inches. In some particular embodiments, the actuators 108 may be spaced from one another by approximately 2.25 inches. These distances can be defined as distances between centerlines of the actuators 108, which can extend parallel to the actuation direction 5.

Each actuator 108 may be disposed at least partly within an actuator housing 124. Referring again to FIGS. 1 and 2, the actuator housing 124 may be affixed to the extrusion die system 1, for example, to the lip adjustment assembly 100. The actuator housing 124 may be removably connected to the lip adjustment assembly 100, such that the actuator housing 124 can be removed as needed to allow for access to the actuators 108. The actuator housing 124 may be formed of a metal, a polymer, and/or the like. It should be understood that the actuator housing 124 should be configured to withstand the temperatures radiating from the heated extrusion die 10 or transferred from the heated extrusion die 10 along the lip adjustment assembly 100.

The lip adjustment assembly 100 may include a single implementation of the actuator housing 124 that is sized and dimensioned to enclose, at least partially, all of the actuators 108 on the lip adjustment assembly 100. In some aspects, the lip adjustment assembly 100 may include a plurality of actuator housings 124, with each actuator housing 124 being configured to house one or more of the plurality of actuators 108.

The actuator housing 124 may include a vent 132 disposed thereon. The vent 132 may define an opening through at least one surface of the actuator housing 124. The vent 132 may allow for air to flow into or out of the actuator housing 124. Airflow around the actuators 108 within the actuator housing 124 can facilitate cooling the actuators 108. The vent 132 can include a grate, lattice, grid, and/or another suitable design of openings. The actuator housing 124 may include a plurality of vents 132.

An air or coolant mover may be disposed on the actuator housing 124. The air or coolant mover can include a fan 128. The fan 128 can move air into and/or out of the actuator housing 124. Movement of air toward and/or away from the actuators 108 may facilitate cooling of the actuators 108. The fan 128 can be connected to a power source and a controller 9 (labeled in FIG. 2) configured to operate the fan 128. The lip adjustment assembly 100 may include a plurality of fans 128. In some aspects, one or more of the plurality of the fans 128 may be configured to move air into the actuator housing 124, while one or more others of the plurality of the fans 128 may be configured to move air out of the actuator housing 124. Such air movement can generate an air flow path that can travel through and/or past the actuators 108, thus cooling the actuators 108.

The air moved into the actuator housing 124 by the fans 128 and/or vents 132 may be sourced from immediately outside of and adjacent to the actuator housing 124. In some aspects, as shown schematically in FIG. 2, the air that is moved into the actuator housing 124 can be delivered via a conduit 136 from an air source 140 that is spaced away from the extrusion die system 1. The conduit 136 may include a hose, duct, and/or the like. The ambient air that is in proximity to the actuator housing 124 may be heated by the heat radiating from the heated extrusion die 10. As such, it may be preferable to move air into the actuator housing 124 that is cooler than the ambient air immediately adjacent to the actuator housing 124. In such aspects, the air source 140 may be disposed at a sufficient distance from the heated extrusion die 10 so as to not be heated by the extrusion die 10 beyond a predetermined value. In some aspects, the environment immediately surrounding the extrusion die 10 can include various volatile gases that have evaporated from the extrusion die system 1 during use. The evaporated volatile gases can condense and leave residues on the actuators 108. As such, it may be preferred to avoid introducing coolant air containing such volatiles into the actuator housing 124, and to, instead, introduce coolant air from a spaced air source 140 that is substantially free of the undesired volatiles. For example, the air source 140 may include outside air. It should be appreciated that, while the description above refers specifically to air, any other suitable coolant may be used.

The extrusion die system 1 can include a controller 9 configured to control operation of various components of the extrusion die system 1, such as the heater 12, the extrusion die 10, components of the lip adjustment assembly 100, and/or the like, such as, but not limited to, the actuator 108, the fan 128, the air source 140, and/or other connected components. The controller 9 can include an input interface for receiving and processing input from a number of input devices, such as a keyboard, a mouse, a touchpad, a touch screen, an electronic stylus, or other type of input device. Similarly, the controller 9 can include an output interface for providing output to a display, such as a computer monitor, a flat-panel display, a digital projector, a printer, a plotter, a touch screen, or other type of output device. The controller 9 can include driver devices to control the extrusion die system 1, such as the heater 12, the extrusion die 10, components of the lip adjustment assembly 100, and/or the like, such as, but not limited to, the actuator 108, the fan 128, the air source 140, and/or other connected components. The extrusion die system 1 can include one or more sensors, such as temperature sensors, flow sensors, position sensors, and/or the like. The controller 9 can include input devices to receive sensor readings from one or more sensors associated with one or more of the extrusion die system 1, such as the heater 12, the extrusion die 10, components of the lip adjustment assembly 100, and/or the like, such as, but not limited to, the actuator 108, the fan 128, the air source 140, and/or other connected components. The controller 9 can include a computing device, which may be a physical computing device or a virtual machine host process and one or more virtual machine instances. Computer-executable instructions may be executed by the physical hardware of a computing device indirectly through interpretation and/or execution of instructions stored and executed in the context of a virtual machine. The controller 9 may include a processor and a memory. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory. The memory may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, or any other device capable of storing digital information. The memory may also include a mass storage device (not shown) such as a hard drive, optical drive, tape drive, non-volatile solid state device or any other device capable of storing digital information. The processor may operate under the control of an operating system that resides in memory. The extrusion die system 1 can include a plurality of controllers 9, and the various components described above and throughout this application can be controlled by one or more of the plurality of controllers 9.

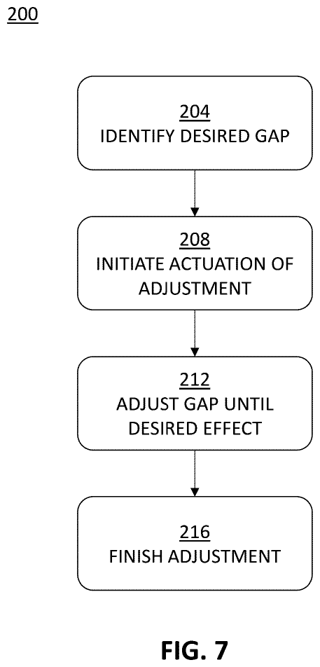

The extrusion die system 1 or any of the components thereof described throughout this application can be operated by a user. FIG. 7 depicts an exemplary method 200 of operation for adjusting the size of the gap 30 between the first lip 18 and the second lip 26. In step 204, the user can determine the desired gap distance 32 that defines the gap 30 between the first lip 18 and the second lip 26. The desired gap distance 32 can correspond to the size of the gap 30 that will result in the desired extrudate shape, pattern, consistency, and/or the like. The user can make this determination based on previously identified data or by monitoring the gap 30 prior to adjustment and deciding the gap distance 32 needs to be changed.

In step 208, the user and/or extrusion die system 1 can actuate the actuator 108. In some aspects, for example where the actuator 108 includes a stepper motor, the actuation can include rotating the rotational component of the actuator 108 by a number of steps. Rotation of the rotational component causes translation of the linear component 110 as described above. The rotation of the rotational component can be implemented by a predetermined number of steps, rotational distance, speed, and/or the like. Incremental movement, such as that movement, of the rotational component can be proportionally linked to an incremental translational movement of the linear component 110. The actuation of the actuator 108 can include a manual turning of the rotational component by the user. In some aspects, the actuation can include the user inputting a command into the extrusion die system 1, for example in the controller 9, to electronically cause the actuator 108 to rotate the rotational component. The actuation can be implemented in a first rotational direction, which results in translation of the linear component 110 along the actuation direction 5 in a first translation direction, or in a second rotational direction opposite the first rotational direction, which results in translation of the linear component 110 along the actuation direction 5 in a second translation direction opposite the first translation direction. One of the first and second translational directions can correspond to movement of the linear component 110 towards the extrusion die 10, and the other of the first and second translational directions can correspond to the movement of the linear component 110 away from the extrusion die 10.

In step 212, the user and/or extrusion die system 1 can determine the duration of actuation of the actuator 108 and/or the translation distance of the linear component 110 based on the desired gap distance 32. The linear component 110 can be connected to the engagement member 104 as described above, which, in turn, causes movement of the one of the first lip 18 and the second lip 26 towards or away from the other of the first lip 18 and the second lip 26. The greater the adjustment to the gap distance 32 is needed, the longer the actuation of the actuator 108 can be, and/or the faster the actuation of the actuator 108 can be. In this regard, a desired effect may be a desired product thickness, a desired coating thickness, a desired film thickness, a desired sheet thickness, and/or the like.

In step 216, the user and/or extrusion die system 1 can terminate actuation of the actuator 108. When the actuator 108 stops operating, the translation of the connected engagement member 104 also stops. When the engagement member 104 is no longer moving, the first lip 18 or second lip 26 that is connected to the engagement member 104 also stops moving towards or away from the other of the first lip 18 and the second lip 26. At this point, the gap distance 32 between the first lip 18 and the second lip 26 is established. It will be appreciated that the gap distance 32 referred to in this step applies only to the distance along the first direction 2 between a point on the first lip 18 and a point on the second lip 26 spaced from the point on the first lip 18 along the first direction 2. In aspects where the lip adjustment assembly 100 includes a plurality of actuators 108, and where at least one of the first lip 18 and the second lip 26 is configured to contort non-linearly (when viewed in a plane defined by the first direction 2 and the second direction 3), the gap distance 32 between adjacent points on the first and second lips 26 along the first direction 2 can still be in the process of being adjusted or can have already been established earlier.

The exemplary method 200 may include steps of actuating a plurality of actuator 108 to adjust the gap distance 32 between different sets of points on the first lip 18 and the second lip 26 spaced from each other along the first direction 2. One or more of the steps above can be repeated one or more times to achieve the desired gap 30 along the entire length of the extrusion die 10 measured along the second direction 3.

The user and/or extrusion die system 1 can also actuate one or more cooling mechanisms configured to cool the one or more actuators 108 in the lip adjustment assembly 100. The cooling steps can include actuating one or more fans 128 to move cooling air or other coolant fluid toward the one or more actuators 108. In some aspects, the cooling step can include actuating one or more fans 128 to move heated air that receives heat from the actuators 108 away from the actuators 108, thus allowing for radiation of heat from the actuators 108 and cooling the actuators 108.

In some aspects, the cooling step can include introducing a cooling air or other coolant from an external implementation of the air source 140. In some aspects, the user can open or otherwise introduce one or more vents 132 within the lip adjustment assembly 100 to allow for better airflow around the actuators 108, thus cooling the actuators 108.

The cooling step can include spacing the actuators 108 at least at a predetermined minimal distance from the extrusion die 10 to decrease the amount of heat that can transfer from the heated extrusion die 10 to the actuators 108. In some aspects, the cooling step can include introducing one or more implementation of the insulation component 122 into the lip adjustment assembly 100, for example, into a coupler 112 disposed between the engagement member 104 and the actuator 108.

The method can also include steps of identifying the desired adjustment distance and/or degree of actuation of the actuators 108 to result in the desired gap distances 32. The identified information can be stored in the controller 9 or in a related controller or computing system for future use. The method can further include retrieving previously stored information pertaining to the desired gap distances 32 and the associated durations, speeds, and other actuation parameters of particular implementations of the actuators 108. By utilizing previously saved information, the system can be calibrated and set up for use much faster than if the user has to identify the necessary operating parameters to achieve the desired gap 30 every time without previously saved information.

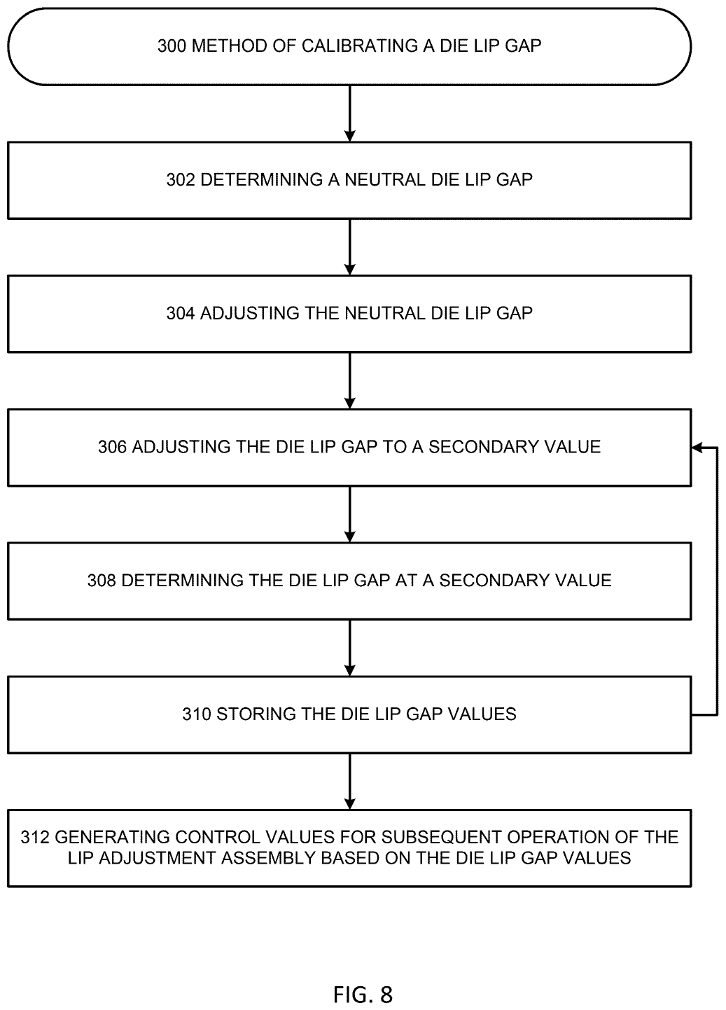

FIG. 8 illustrates an exemplary method of calibrating a die lip gap according to aspects of the disclosure.

In particular, FIG. 8 shows an exemplary method of calibrating a die lip gap 300 of the disclosure. In this regard, the method of calibrating a die lip gap 300 may involve a method of calibrating the lip adjustment assembly 100. In particular, it should be noted that the method of calibrating a die lip gap 300 is merely exemplary and may be modified consistent with the various aspects disclosed herein. It should be noted that the method of calibrating a die lip gap 300 may be performed in a different order consistent with the aspects described above. Moreover, the method of calibrating a die lip gap 300 may be modified to have more or fewer process steps consistent with the various aspects disclosed herein.

Further, the method of calibrating a die lip gap 300 may be implemented during manufacture, during initial usage, from time to time during usage, and/or the like. Various values determined by the method of calibrating a die lip gap 300 may be expedite operation of the lip adjustment assembly 100 and/or may be utilized for future operation of the lip adjustment assembly 100.

The method of calibrating a die lip gap 300 of the disclosure may include determining a neutral die lip gap 302. In this regard, the determining a neutral die lip gap 302 may include any one or more materials, structures, arrangements, processes, and/or the like as described herein. Moreover, one or more proceeding or subsequent processes may also be implemented with respect to the determining a neutral die lip gap 302 consistent with the disclosure.

The neutral die lip gap of the lip adjustment assembly 100 may be checked with feeler gauges, sensors as described herein, and/or the like after being heated to operating temperature.

The method of calibrating a die lip gap 300 of the disclosure may include adjusting the neutral die lip gap 304. In this regard, the adjusting the neutral die lip gap 304 may include any one or more materials, structures, arrangements, processes, and/or the like as described herein. Moreover, one or more proceeding or subsequent processes may also be implemented with respect to the adjusting the neutral die lip gap 304 consistent with the disclosure.

In this regard, the lip adjustment assembly 100 may then tuned. In aspects, the actuators 108 may be adjusted until the gap is very uniform at the desired neutral gap. These settings may be designated as the maximum lip gap for lip adjustment assembly 100. For example, the maximum lip gap for the lip adjustment assembly 100 may be typically 0.040″ on cast film dies. In aspects, the actuators 108 may implement a linear relationship with a lip gap. In other aspects, the actuators 108 may implement a nonlinear relationship with the lip gap.

For example, when the actuators 108 are actuated the lip gap does not change exactly proportionately with an operation of the actuators 108. This is because the adjustments are at an angle to the lip gap and the flex lip may move through an arc due to the mechanical flexure of the hinge in the die body. In particular aspects of the actuators 108, when the motors engage with the adjusting threads, the lip gap does not change exactly proportionately with the number of turns. This is because the adjustments are at an angle to the lip gap (typically 45 degrees) and the flex lip moves through an arc due to the mechanical flexure of the hinge in the die body.

The method of calibrating a die lip gap 300 of the disclosure may include adjusting the die lip gap to a secondary value 306. In this regard, the adjusting the die lip gap to a secondary value 306 may include any one or more materials, structures, arrangements, processes, and/or the like as described herein. Moreover, one or more proceeding or subsequent processes may also be implemented with respect to the adjusting the die lip gap to a secondary value 306 consistent with the disclosure. In this regard, the lip adjustment assembly 100 may implement the actuators 108 to obtain a secondary gap value.

The method of calibrating a die lip gap 300 of the disclosure may include determining the die lip gap at a secondary value 308. In this regard, the determining the die lip gap at a secondary value 308 may include any one or more materials, structures, arrangements, processes, and/or the like as described herein. Moreover, one or more proceeding or subsequent processes may also be implemented with respect to the determining the die lip gap to a secondary value 308 consistent with the disclosure. The secondary die lip gap of lip adjustment assembly 100 may be determined with feeler gauges, sensors as described herein, and/or the like while being heated to operating temperature.

In this regard, in aspects to accurately calibrate lip adjustment assembly 100, other gaps need to be set and checked with feeler gages or sensors. For example, set gaps may include 0.030″, 0.020″, and 0.010″ and check the actual result with feeler gages or sensors.

The method of calibrating a die lip gap 300 of the disclosure may include storing the die lip gap to a secondary value 310. In this regard, the storing the die lip gap to a secondary value 310 may include any one or more materials, structures, arrangements, processes, and/or the like as described herein. Moreover, one or more proceeding or subsequent processes may also be implemented with respect to the storing the die lip gap to a secondary value 310 consistent with the disclosure. Further, the method of calibrating a die lip gap 300 may include repeating the adjusting the die lip gap to a secondary value 306 and the determining the die lip gap to a secondary value 308 for additional secondary values.

The method of calibrating a die lip gap 300 of the disclosure may include generating control values for subsequent operation of the lip adjustment assembly based on the die lip gap values 312. In this regard, the generating control values for subsequent operation of the lip adjustment assembly based on the die lip gap values 312 may include any one or more materials, structures, arrangements, processes, and/or the like as described herein. Moreover, one or more proceeding or subsequent processes may also be implemented with respect to the generating control values for subsequent operation of the lip adjustment assembly based on the die lip gap values 312 consistent with the disclosure.

In aspects, the set of data points (intended gap versus measured gap) may be used to create a polynomial curve fit such that, after applying this fitted curve to the control system, the future intended gaps and actual gaps match very precisely over the normal operating range. Once this calibration has been completed there is no need for any gap measuring device to be employed going forward. The user can input the desired gaps and the system will accurately and repeatably achieve those gaps.

In aspects, the set of data points (intended gap versus measured gap) may be used to create a lookup table. Thereafter, the lookup table may be utilized such that the future intended gaps and actual gaps match very precisely over the normal operating range.

Accordingly, the disclosure as set forth an improved lip adjustment assembly that increases the accuracy of the lip adjustment without adversely affecting the extrudate, decreases the amount of time to implement adjustments, and/or the like.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

When values are expressed as approximations by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, reference to values stated in ranges includes each and every value within that range.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

1. A lip adjustment assembly for adjusting thickness of an extrudate, the lip adjustment assembly comprising:
an engagement member operably connected to a movable lip of an extrusion die, the engagement member being movable in a first direction and in a second direction opposite the first direction;
an actuator configured to selectively move the engagement member in the first direction and in the second direction; and
a coupler operably connected to both the engagement member and the actuator, such that the coupler is disposed between the engagement member and the actuator,
wherein when the engagement member is moved in the first direction, the movable lip is moved toward a second lip of the extrusion die, and when the engagement member is moved in the second direction, the movable lip is moved away from the second lip.

2. The lip adjustment assembly of claim 1, wherein the actuator comprises a stepper motor having a rotational component and a linear component, wherein movement of the rotational component in a first rotational direction causes movement of the linear component in a first linear direction, and movement of the rotational component in a second rotational direction opposite the first rotational direction causes movement of the linear component in a second linear direction opposite the first linear direction.

3. The lip adjustment assembly of claim 2, wherein the linear component is configured to be moved by a predetermined linear distance that is proportional to a predetermined rotational distance of the rotational component.

4. The lip adjustment assembly of claim 1, further comprising an insulator disposed on the coupler, the insulator being configured to impede conduction of heat from the engagement member to the actuator.

5. The lip adjustment assembly of claim 4, wherein the coupler has a first thermal conductivity, the insulator has a second thermal conductivity, and the second thermal conductivity is lower than the first thermal conductivity.

6. The lip adjustment assembly of claim 4, wherein the coupler comprises a recess configured to receive the insulator therein.

7. The lip adjustment assembly of claim 1, wherein the coupler comprises a first portion coupled to the actuator and a second portion coupled to the engagement member, the first portion being spaced from the second portion.

8. The lip adjustment assembly of claim 4, wherein the coupler comprises a first portion coupled to the actuator and a second portion coupled to the engagement member, the first portion being spaced from the second portion, and wherein the first portion comprises a first recess and the second portion comprises a second recess, the insulator being disposed in the first recess and the second recess.

9. The lip adjustment assembly of claim 8, wherein the insulator is disposed between the first portion and the second portion.

10. The lip adjustment assembly of claim 1, wherein the actuator, the coupler, and the engagement member that are connected to each other constitute a set of components, and wherein the lip adjustment assembly comprises a plurality of sets of components, with each set of components having at least one actuator, at least one coupler, and at least one engagement member.

11. The lip adjustment assembly of claim 1, further comprising a housing configured to at least partially enclose the actuator therein.

12. The lip adjustment assembly of claim 11, wherein the housing defining an air vent extending therethrough, the air vent being configured to permit movement of air into and out of the housing.

13. The lip adjustment assembly of claim 1, further comprising an air mover configured to actively move air toward or away from the actuator.

14. The lip adjustment assembly of claim 1, further comprising a controller configured to control operation of the actuator.

15. The lip adjustment assembly of claim 1, further comprising a plurality of actuators arranged in a linear array, wherein each actuator of the plurality of actuators is spaced from at least an adjacent one of the plurality of actuators by a distance of between about 1 inch and about 4 inches measured between centerlines of each actuator of the plurality of actuators and the at least adjacent one of the plurality of actuators.

16. An extrusion die for use with an extrusion die system, the extrusion die being configured to receive a material therein, the extrusion die comprising:
a first die body having a first lip;
a second die body having a second lip; and
a gap defined between the first lip and the second lip, the gap being configured to receive the material therein and to extrude the material therefrom;
wherein the extrusion die is configured to be operably connected to a lip adjustment assembly for adjusting a thickness of an extruded material, the lip adjustment assembly comprising:
an engagement member operably connected to one of the first lip and the second lip and being movable in a first direction and in a second direction opposite the first direction;
an actuator configured to selectively move the engagement member in the first direction and in the second direction; and
a coupler operably connected to both the engagement member and the actuator, such that the coupler is disposed between the engagement member and the actuator,
wherein when the lip adjustment assembly is connected to the extrusion die and the engagement member of the lip adjustment assembly is moved in the first direction, the one of the first lip and the second lip is moved toward the other of the first lip and the second lip, and when the engagement member is moved in the second direction, the one of the first lip and the second lip is moved away from the other of the first lip and the second lip.

17. The extrusion die of claim 16, further comprising an insulator configured to impede heat transfer from the extrusion die to the lip adjustment assembly when the lip adjustment assembly is connected to the extrusion die.

18. The extrusion die of claim 16, wherein the coupler has a first thermal conductivity, the insulator has a second thermal conductivity, and the second thermal conductivity is less than the first thermal conductivity.

19. The extrusion die of claim 16, wherein one of the first lip and the second lip is configured to be deformed non-linearly along a length thereof by a plurality of actuators, couplers, and engagement members of the lip adjustment assembly.

20. The extrusion die of claim 16, further comprising a heater configured to heat the material in the extrusion die.

21. The extrusion die of claim 16, wherein one of the first die body and the second die body comprises a flexible hinge adjacent the respective first or second lip, the flexible hinge being configured to deform when one of the first and second lips is moved towards or away from the other of the first and second lips.

22. The extrusion die of claim 16, wherein one of the first and second lips is configured to be moved by the lip adjustment assembly while the other of the first and second lips is not movable by the lip adjustment assembly.

23. An extrusion die system for forming extrudate from a material, the extrusion die system comprising:
an extrusion die having:
a first die body having a first lip;
a second die body having a second lip; and
a gap defined between the first lip and the second lip, the gap being configured to receive the material therein and to extrude the material therefrom;
a heater configured to heat the material in the extrusion die;
a lip adjustment assembly having:
an engagement member operably connected to one of the first lip and the second lip and being movable in a first direction and in a second direction opposite the first direction;
an actuator configured to selectively move the engagement member in the first direction and in the second direction; and
a coupler operably connected to both the engagement member and the actuator, such that the coupler is disposed between the engagement member and the actuator,
wherein when the engagement member is moved in the first direction, the one of the first lip and the second lip is moved toward the other of the first lip and the second lip, and when the engagement member is moved in the second direction, the one of the first lip and the second lip is moved away from the other of the first lip and the second lip; and
a controller configured to control operation of the heater and the lip adjustment assembly.

24-59. (canceled)
